(19) United States
(12) Patent Application Publication
(10) Pub. No.: US 2014/0191970 A1
(43) Pub. Date: Jul. 10, 2014

(54) TERMINAL TO SET A TOUCH LOCK LAYER, AND METHOD THEREOF

(71) Applicant: Pantech Co., Ltd., Seoul (KR)

(72) Inventors: Yong Hoon CHO, Seoul (KR); Sun Mi Kim, Seoul (KR)

(73) Assignee: Pantech Co., Ltd., Seoul (KR)

(21) Appl. No.: 14/152,192

(22) Filed: Jan. 10, 2014

(30) Foreign Application Priority Data
Jan. 10, 2013 (KR) 10-2013-0002988

(51) Int. Cl. G09G 5/00; G06F 3/0354

(52) U.S. Cl. CPC G09G 5/006; G06F 3/03543
USPC 345/163; 345/173

(57) ABSTRACT

There is provided a method and a terminal to sets a touch lock layer. The terminal comprising, a display displaying a layer including an image object and an operable touch lock layer within being overlapped each other, an input unit receiving a user input for at least one of the displayed layers, and a control unit controlling the operable touch lock layer based on the user input.

### CROSS-REFERENCE TO RELATED APPLICATION

This application claims priority from and the benefits under 35 U.S.C. §119 to Korean Patent Application No. 10-2013-0002988, filed on Jan. 10, 2013, the content of which is incorporated herein in its entirety by reference.

### BACKGROUND

1. Field

The present disclosure relates to a device and method for setting a touch lock layer of a terminal by a user.

2. Discusion of the Background

A touch screen terminal is generally provided with 1) a screen lock functionality allowing a touch input to some regions to prevent the terminal from malfunctioning due to an erroneous touch input occurring when a user does not use the terminal, or 2) a harmful information blocking program (application) functionality for restricting the execution of applications. However, such functionality may not be commonly used by a user unless the functionality is provided by a program, and there is a problem in that restrictions may not be set on a specific function of the program, a specific region, or the like.

A terminal user may need a touch lock function only for a specific screen state of a specific application or a specific part of a background screen. For example, an emergency call is generally available on an initial locked screen and access to the emergency call button is not limited. In an example, a child may touch the screen and call 911 or the like. In such a case, a functionality operated by a user, such as, a functionality to set a touch lock to control access to an emergency call input on the initial locked screen may be desired.

### SUMMARY

The present disclosure is directed to providing a method and a device for setting a touch lock layer according to user's convenience.

By setting a touch lock layer according to a user's intention for each layer displayed on a display, a malfunction of a terminal due to an unexpected touch is prevented, and the user's convenience is promoted.

Additional features of the invention will be set forth in the description that follows, and in part will be apparent from the description, or may be learned by practice of the invention.

It is to be understood that both the foregoing general description and the following detailed description are exemplary and explanatory and are intended to provide further explanation of the invention as claimed.

In one aspect, there is provided a terminal that sets a touch lock layer. The terminal includes: a display displaying a layer including an image object and an operable touch lock layer within being overlapped each other; an input unit receiving a user input for at least one of the displayed layers; and a control unit controlling the operable touch lock layer based on the user input.

In addition, the control unit may include: a touch lock layer creating unit creating the operable touch lock layer; and a touch lock layer mapping unit mapping the created touch lock layer into the layer including the image object.

In addition, the image object may include at least one area of the display or an icon displayed on the display.

In addition, the control unit may further include a touch lock layer changing unit changing a shape or a position of the touch lock layer based on the user input.

In addition, the user input may include an input using at least one of a finger, a touch pen, and a mouse. Furthermore, the changed shape of the touch lock layer may include at least one of a size, a color, a degree of transparency, and an image of the touch lock layer.

In addition, the input unit may sense a movement of the user input in a state in which a predetermined portion of the touch lock layer is selected, and the touch lock layer changing unit may change the size of the touch lock layer in response to the movement.

In addition, the touch lock layer changing unit may provide a selection of at least one of a size, a color, a degree of transparency, and an image of the touch lock layer on a setting menu for the touch lock layer and change the touch lock layer for an item selected by a user.

In addition, the input unit may sense a movement of the user input in a state in which a predetermined portion of the touch lock layer is selected, and the touch lock layer changing unit may change the size of the touch lock layer in response to the movement.

In addition, the touch lock layer creating unit may divide a cover layer positioned on the layer including the image object into a plurality of areas and create a touch lock layer in at least one area selected by a user from among the plurality of areas.

In addition, the touch lock layer creating unit may create at least one closed area drawn on the display as the touch lock layer in response to a user input for the layer including the image object.

In addition, when the closed area is drawn in both a fixed region and a non-fixed region of the layer including the image object, the touch lock layer mapping unit may map the touch lock layer into the fixed region.

In addition, an encryption unit setting and storing a password for the touch lock layer and allowing the touch lock layer to be changeable in a case where an accurate password is input may be further included.

In addition, a storage unit storing mapping information of the touch lock layer for the layer including the image object may be further included.

In addition, when a request for the stored layer including the image object is made, the control unit may extract the layer including the image object from the storage unit by applying the mapping information and provide the display the extracted layer.

In another aspect, there is provided a method of setting a touch lock layer. The method includes: displaying a layer including an image object and an operable touch lock layer within being overlapped each other; receiving a user input for at least one of the displayed layers; and controlling the operable touch lock layer based on the user input.

In addition, said controlling of the operable touch lock layer may further include: creating the operable touch lock layer; and mapping the created touch lock layer into the layer including the image object.

In addition, the image object may be at least one area of the display or an icon displayed on the display.

In addition, said controlling of the operable touch lock layer based on the user input may include changing a shape or a position of the touch lock layer based on the user input.

In addition, the user input may include an input using at least one of a finger, a touch pen, and a mouse.

In addition, the changed shape of the touch lock layer may include at least one of a size, a color, a degree of transparency, and an image of the touch lock layer.

In addition, in said changing of a shape or a position of the touch lock layer, a movement of the user input may be sensed in a state in which a predetermined portion of the touch lock layer is selected, and the size of the touch lock layer may be changed.

In addition, in said changing of a shape or a position of the touch lock layer, a selection of at least one of a size, a color, a degree of transparency, and an image of the touch lock layer may be provided on a setting menu for the touch lock layer, and the touch lock layer may be changed for an item selected by a user.

In addition, in said changing of a shape or a position of the touch lock layer, a movement of the user input may be sensed in a state in which a predetermined portion of the touch lock layer is selected, and the position of the touch lock layer may be changed.

In addition, in said creating of the operable touch lock layer, a cover layer positioned on the layer including the image object may be divided into a plurality of areas, and a touch lock layer may be created in at least one area selected from among the plurality of areas.

In addition, in said creating of the operable touch lock layer, a closed area drawn on the display may be created as the touch lock layer in response to a movement of the user input.

In addition, in said mapping of the created touch lock layer into the layer, when the closed area is drawn in both a fixed region and a non-fixed region of the layer, the touch lock layer may be mapped into the fixed region.

In addition, setting and storing a password for the touch lock layer and allowing the touch lock layer to be changeable in a case where an accurate password is input may be further included.

In addition, storing mapping information of the touch lock layer for the layer including the image object may be further included.

In addition, it may be further included providing the display the layer including the image object by applying the mapping information when a request for the stored layer including the image object is made.

### BRIEF DESCRIPTION OF THE DRAWINGS

The above and other aspects, features and advantages of the disclosed exemplary embodiments will be more apparent from the following detailed description taken in conjunction with the accompanying drawings. The accompanying drawings, which are included to provide a further understanding of the invention and are incorporated in and constitute a part of this specification, illustrate embodiments of the invention, and together with the description serve to explain the principles of the invention.

FIG. 1 illustrates a configuration diagram of a terminal that sets a touch lock layer according to exemplary embodiments.

FIG. 2 illustrates a configuration diagram of a terminal setting a touch lock layer according to exemplary embodiments.

FIG. 3A, FIG. 3B, FIG. 3C, FIG. 3D, FIG. 3E and FIG. 3F illustrate a layer and a touch lock layer according to exemplary embodiments.

FIG. 4, FIG. 5A and FIG. 5B illustrate creating a touch lock layer in accordance with exemplary embodiments.

FIG. 6 is a perspective view illustration of a touch lock layer mapped into a non-lock layer in accordance with exemplary embodiments.

FIG. 7 illustrates a layer configured to include a fixed region and a non-fixed region in accordance with exemplary embodiments.

FIG. 8A and FIG. 8B illustrate changing a size of a touch lock layer according to exemplary embodiments.

FIG. 9 illustrates a menu window for changing a touch lock layer in accordance with exemplary embodiments.

FIG. 10A, FIG. 10B, FIG. 10C and FIG. 10D illustrate touch lock layers changed in accordance with exemplary embodiments.

FIG. 11 illustrates moving a touch lock layer in accordance with exemplary embodiments.

FIG. 12 illustrates setting a password to a touch lock layer in accordance with exemplary embodiments.

FIG. 13 is a flowchart illustrating a method for setting a touch lock layer in accordance with exemplary embodiments.

FIG. 14 is a flowchart illustrating a method for controlling an operable touch lock layer according to exemplary embodiments.

FIG. 15 is a flowchart of a mapping operation where a touch lock layer is created over a fixed region and a non-fixed region of a layer to be matched according to exemplary embodiments.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments described here may include an aspect that is or may be implemented entirely by hardware, partially by hardware and partially by software, or entirely by software. In description here, a “unit”, a “module”, an “apparatus”, a “system”, or the like denotes a computer-related entity that is implemented by hardware, a combination of hardware and software, software, or the like. For example, in the description here, a unit, a module, an apparatus, a system, or the like may be a process that is in the middle of execution, a processor, an object, an executable file, a thread of execution, a program, and/or a computer, but is not thereto. For example, both an application that is executed in a computer and the computer may correspond to a unit, a module, an apparatus, a system, and the like described here.

Embodiments have been described with reference to a flowchart illustrated in the drawings. While the method is illustrated and described as a series of blocks for the simplification of the description, the present disclosure is not limited to the order of the blocks. Thus, some blocks may be performed in an order different from that described and illustrated here or simultaneously, and various other branching, flow paths, and orders of blocks achieving the same result or a result similar thereto may be implemented. In addition, all the illustrated blocks may not be required for realizing the method described here. Furthermore, a method according to an embodiment of the present disclosure may be realized in the form of a computer program for executing a series of procedures, and the computer program may be recorded on a computer-readable recording medium.

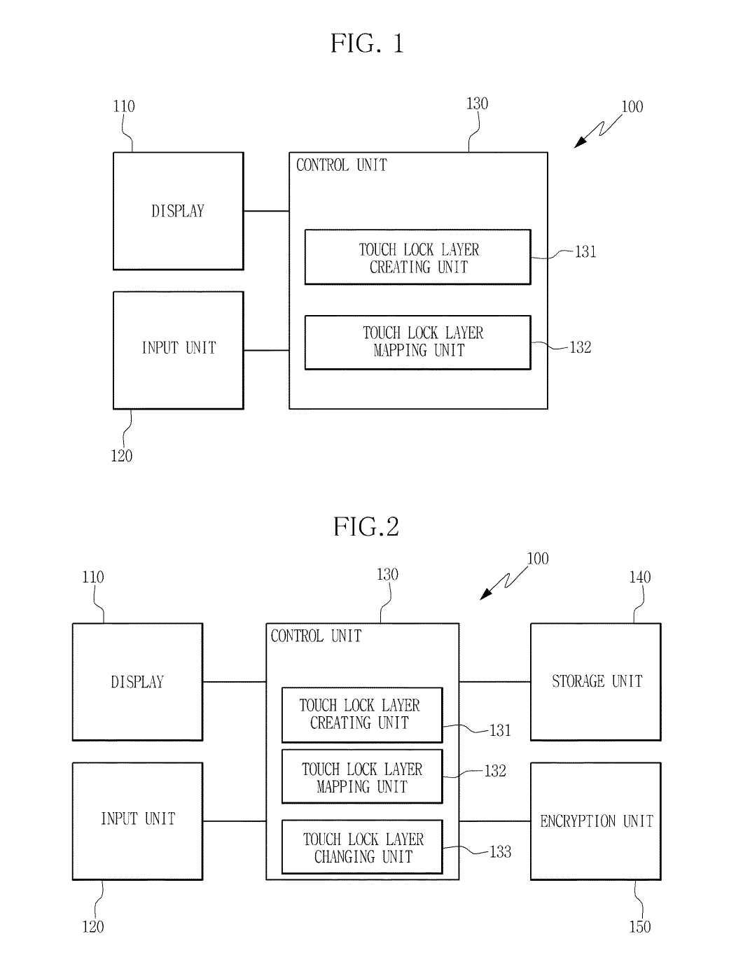

FIG. 1 illustrates a configuration diagram of a terminal that sets a touch lock layer according to exemplary embodiments. A terminal 100 may set a touch lock layer. The terminal 100 may include a display 110, an input unit 120, and a control unit 130.

The control unit 130 of the terminal 100 may include a touch lock layer creating unit 131 and a touch lock layer mapping unit 132.

The terminal 100 may be an information device, such as, a personal computer (PC), a portable multimedia player (PMP), a tablet PC, a personal digital assistant (PDA), a smartphone, an MP3 player, a mobile communication terminal, a digital camera, or the like, and the terminal 100 may include a wireless communication interface unit (not illustrated in the figure) to wirelessly communicate with a server, a base station, or the like.

According to exemplary embodiments, the display 110 is a device that may provide information received from the control unit 130 as visual information to a user. Display 110 may be a Liquid Crystal Display (LCD), a light emitting polymer display (LPD), an Organic Light Emitting Diode (OLED), an Active-Matrix Organic Light-Emitting Diode (AMOLED), or the like, and may include a sensor, such as, a touch screen, to receive a touch input.

The display 110 may display a booting screen, a standby screen, an initial locked screen, a menu screen, a phone call screen, an application execution screen or the like by overlapping layers that include image objects. According to exemplary embodiments, the display 110 may include a touch lock layer on the layers including the image objects. In other words, the display 110 may perform a display by overlapping layers including image objects and an operable touch lock layer, and the image object may be at least one area of the display or an icon displayed on the display. The layers may be created or generated by the control unit 130. In exemplary embodiments, the touch lock layer may be created or generated by the touch lock layer creating unit 131. In exemplary embodiments, the layers may be mapped by the touch lock layer mapping unit 132.

The screen displayed on the display 110 may be configured by one or more layers including a plurality of image objects. The screen displayed on the display 110 may illustrate, for example, an initial locked screen, a background screen, an application to be executed, or the like, in the terminal, through the layers. One screen may be configured by overlapping one or more layers each other. The touch lock layer is one type of such layer. The touch lock layer is positioned on an uppermost layer out of one or more layers displayed on the screen, and may restrict a touch input.

According to exemplary embodiments, the input unit 120 may receive a user input. The user input may be a touch input for the display 110, and, in such a case, the display 110 may include the input unit 120 as a sensing unit, such as, a touch screen.

The user input may include a touch from a finger, a touch pen, or the like. The user input may include an input using at least one of a finger, a touch pen, a mouse, or the like. When the user input is made by using a mouse, the input unit 120 may detect a movement of the mouse displayed on the display 110. On the other hand, when the user input is made by using a finger, a touch pen, or the like, the input unit 120 may sense a movement of a finger, a touch pen, or the like, that is adjacent to the display by using a touch screen or the like. Even when not being directly touched, the input unit 120 may receive a user input by sensing a movement of an object moving adjacently to the display by using a sensing unit, for example, a static electricity sensor, an ultrasonic sensor, an infrared sensor, or the like, as the user input.

When the user input is a direct touch on the screen or an input in proximity to the screen, the input unit 120 may be configured by a touch sensor, such as, a capacitive-type sensor, a resistive overlay-type sensor, an infrared-type sensor, a proximity sensor array, or a pressure sensor, but is not limited thereto. The input unit 120 senses a user's touch input, generates a sense signal including coordinate information relating to the coordinate at which the touch occurs, and transmits the sense signal to the control unit 130. In addition, the input unit 120 may sense a movement of an object in proximity to the display 110 as a user input. Hereinafter, while the user input will be described as a touch input, it should be understood that the touch input described here includes proximity sensing.

According to exemplary embodiments, the control unit 130 may control an operable touch lock layer positioned on the layer including image objects in response to a movement of the user's input that is input to the input unit 120. The control unit 130 may include a touch lock layer creating unit 131 creating an operable touch lock layer on the layer including image objects. The control unit 130 may include a touch lock layer mapping unit 132 mapping the created touch lock layer into the layer.

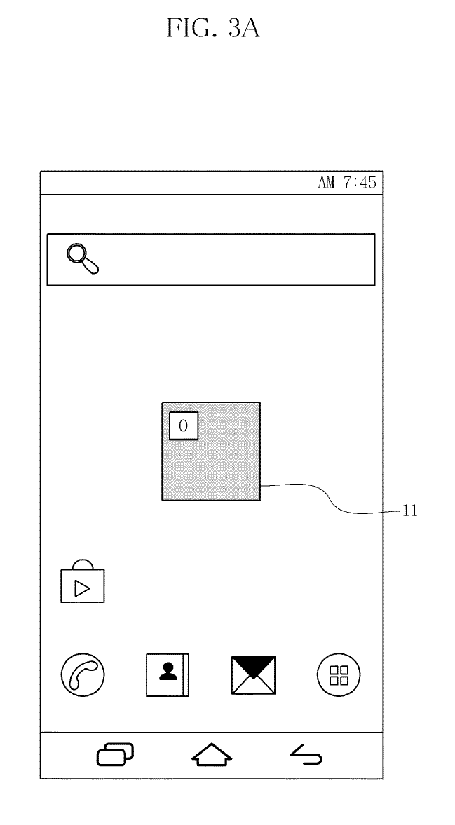

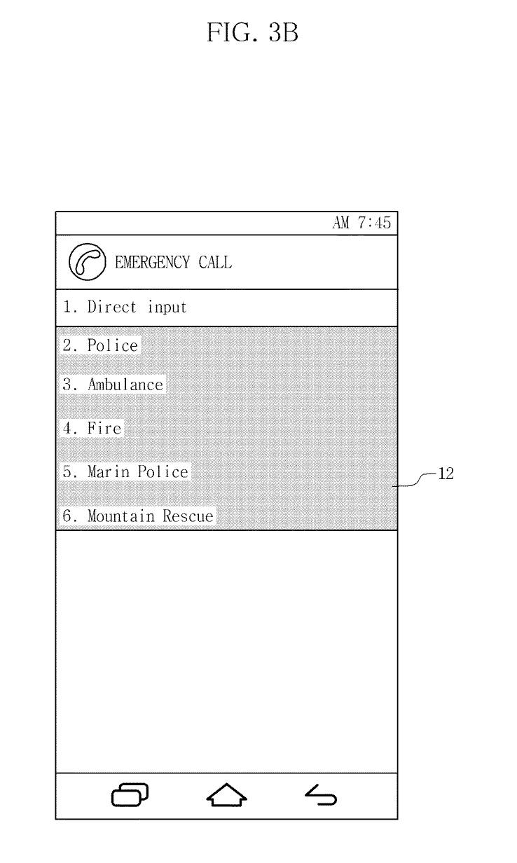

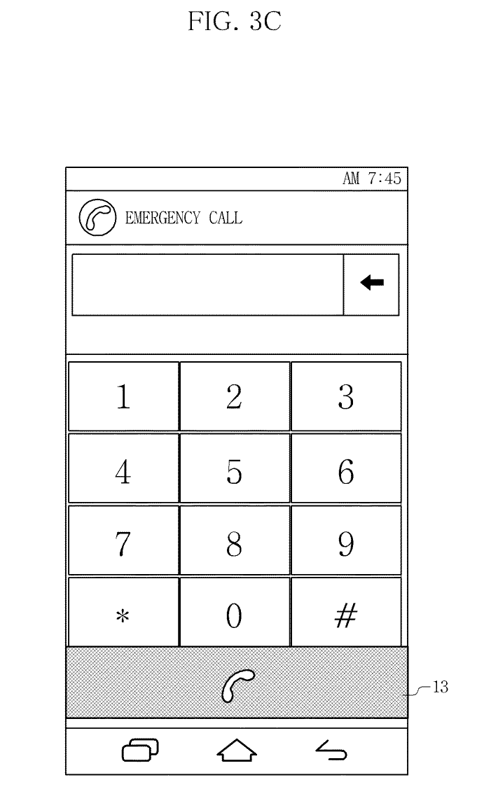

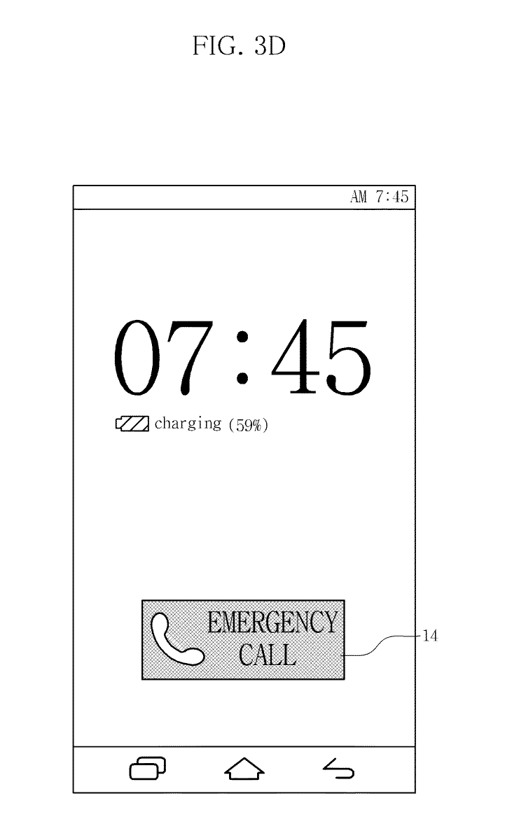

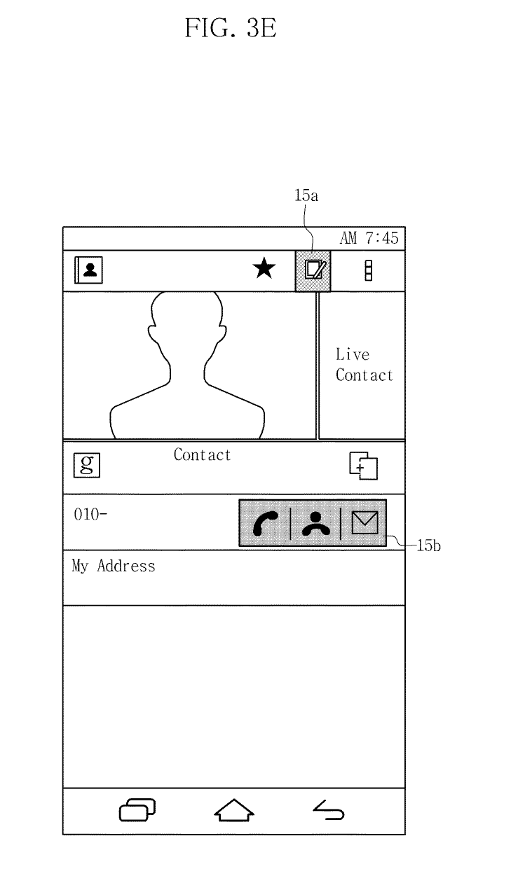

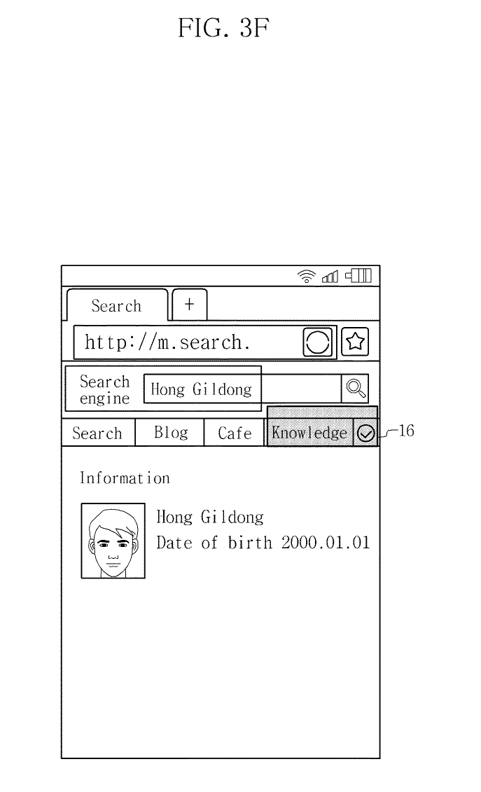

FIG. 3A, FIG. 3B, FIG. 3C, FIG. 3D, FIG. 3E and FIG. 3F illustrate a layer and a touch lock layer according to exemplary embodiments of the present disclosure.

The layer including image objects described here may be configured by image constituent elements as a screen displayed on the display 110. In other words, the layer may include an initial locked screen, a background screen, and an execution screen of an application executable in the terminal, but is not limited thereto.

For example, referring to FIG. 3A, a background screen, application icons, and a widget are image objects and are activated to be displayed in the foreground. In addition, in a state illustrated in FIG. 3B, an emergency call list is an image object and is activated in the foreground. In states illustrated in FIG. 3C and FIG. 3D, an emergency call dial and an initial locked screen layer are activated in the foreground. In addition, in states illustrated in FIG. 3E and FIG. 3F, a phone book modifying layer and a web page are displayed as foreground layers including image objects.

The layers described herein are not limited to those described above but may include, for example, an operation layer in a camera photograph mode and various layers in a game executed through an application.

As described above, the display 110 may display various images through layers including various kinds of image objects.

The touch lock layer is a layer that is positioned in the uppermost layer out of layers displayed on the display and blocks a touch input from being sent to the layer including the image object, and may be applied to the entire screen of the display or a region thereof. According to exemplary embodiments, the touch lock layer may be present in correspondence with a specific portion of another layer positioned or disposed below the touch lock layer.

When the touch lock layer is set, the control unit 130 may ignore the touch input that is input to the corresponding area. Accordingly, even when there is a touch input in a portion in which the touch lock layer is set, the terminal 100 may not respond to the touch input.

In FIG. 3A, an opaque rectangular area 11 located, for example, at a center portion of the screen, is an exemplary touch lock layer. Similarly, in FIG. 3B opaque area 12 is an exemplary touch lock layer, in FIG. 3C opaque area 13 is an exemplary touch lock layer, in FIG. 3D opaque area 14 is an exemplary touch lock layer, in FIG. 3E opaque area 15b is an exemplary touch lock layer, and in FIG. 3F opaque area 16 is an exemplary touch lock layer. In exemplary embodiments, an opaque rectangular area indicating a touch lock layer maybe visually distinct, for example, the touch lock layer may have a red frame to represent a touch lock layer. In the present disclosure, the touch lock layer is an operable touch lock layer. The shape of the touch lock layer may change based on a user input and may include the size, the color, the position, the image, and the like of the touch lock layer.

In addition, the color, shape or size of the touch lock layer is not limited to the representations illustrated in FIG. 3A, FIG. 3B, FIG. 3C, FIG. 3D, FIG. 3E and FIG. 3F. According to exemplary embodiments, the touch lock screen may be displayed with a transparent color. As illustrated in FIG. 3E, a plurality of touch lock layers may be set to the layer on one screen. Specifically, the touch lock layer may be an area of a cover layer positioned as the uppermost layer of a plurality of layers. Here, the cover layer may represent a layer positioned in the uppermost layer out of layers displayed on the display.

In exemplary embodiments, the touch lock layer creating unit 131 may create an operable touch lock layer on the layers. Specifically, the touch lock layer creating unit 131 may create a cover layer in the uppermost layer of layers and selectively create a touch lock layer (touch lock area) in an area, whole or in-part, of the cover layer.

The touch lock layer creating unit 131 may create a touch lock layer in accordance with selection of a specific icon, an operation of a specific key defined in advance, or an operation (for example, a shake) of the terminal. For example, the touch lock layer creating unit 131, as illustrated in FIG. 3A, may create a touch lock layer 11 at the center of the screen. Particularly, the touch lock layer creating unit 131 may form a touch lock layer on the screen currently displayed by the display 110. FIG. 3B, FIG. 3C, FIG. 3D, FIG. 3E and FIG. 3F illustrate similar touch lock layers.

When the touch lock layer is created, a rectangular opaque window, for example, defined as a form in advance, is created. In exemplary embodiments, the touch lock layer creating unit 131 may create a touch lock layer in accordance with inputs as described below.

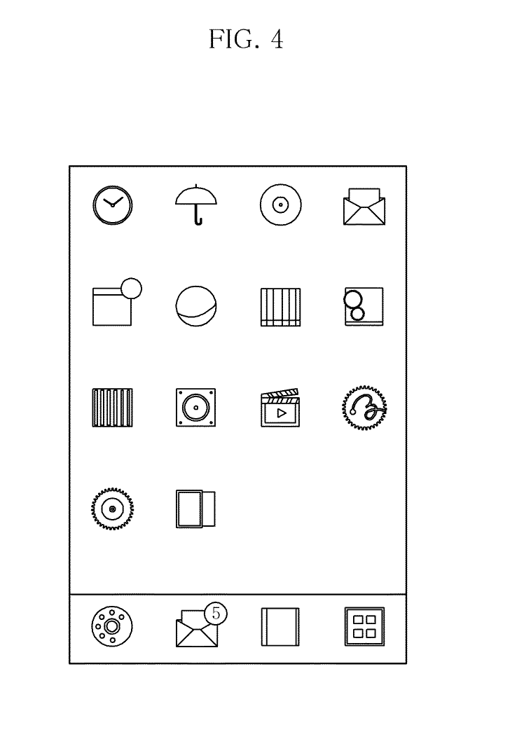

FIG. 4, FIG. 5A and FIG. 5B are illustrate creating a touch lock layer in accordance with exemplary embodiments.

As illustrated in FIG. 4, in order to create a touch lock layer, the touch lock layer creating unit 131 may divide a cover layer positioned on a layer representing a background screen into a plurality of areas and enable a user to discriminate the areas by representing the divided areas in mutually-different visual effects, for example, colors or degrees of transparency.

As illustrated in FIG. 4, in selecting a touch lock layer, the touch lock layer creating unit 131 may set at least one area selected by a user as the touch lock layer (area). For example, when portions of the background screen including an email icon and a calendar icon are selected by the user, the touch lock layer creating unit 131 may create touch lock layers in the two areas overlapping or associated with these portions.

As illustrated in FIG. 5A and FIG. 5B, the touch lock layer creating unit 131 may form a touch lock layer with an arbitrary form defining a closed area drawn on the display 110. As illustrated in FIG. 5A, the touch lock layer creating unit 131 may create a touch lock layer in an arbitrary area drawn using a mouse, a touch pen, a finger, or the like. When the lines to define a touch lock layer area are not closed or do not meet together, a closed area may be configured by arbitrarily connecting a start point and an end point. In addition, as illustrated in FIG. 5B, the touch lock layer creating unit 131 may create a touch lock layer in a rectangular shape including a line formed by drawing a touch pen or the like to a position B in a state being in touch with a point A as a diagonal line thereof.

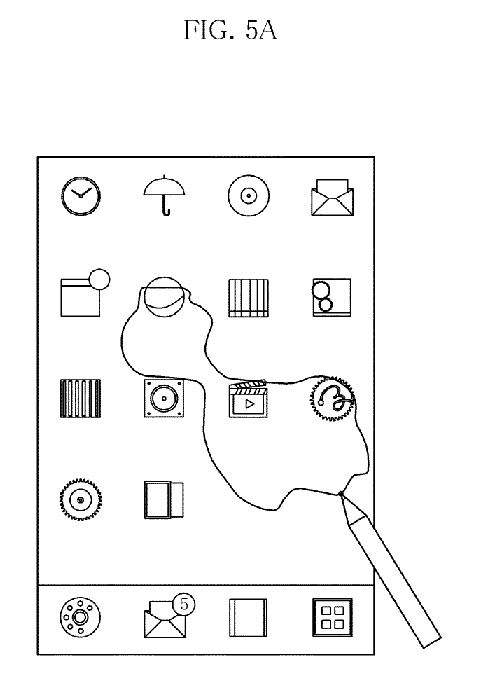

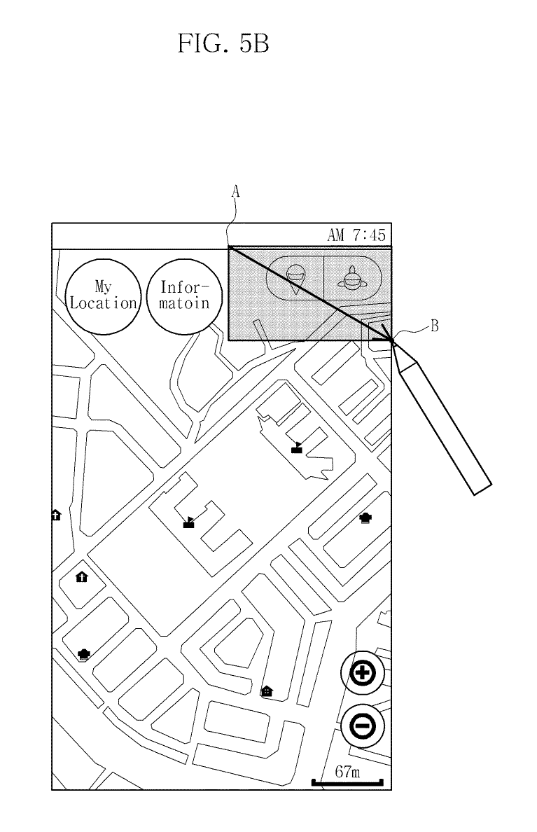

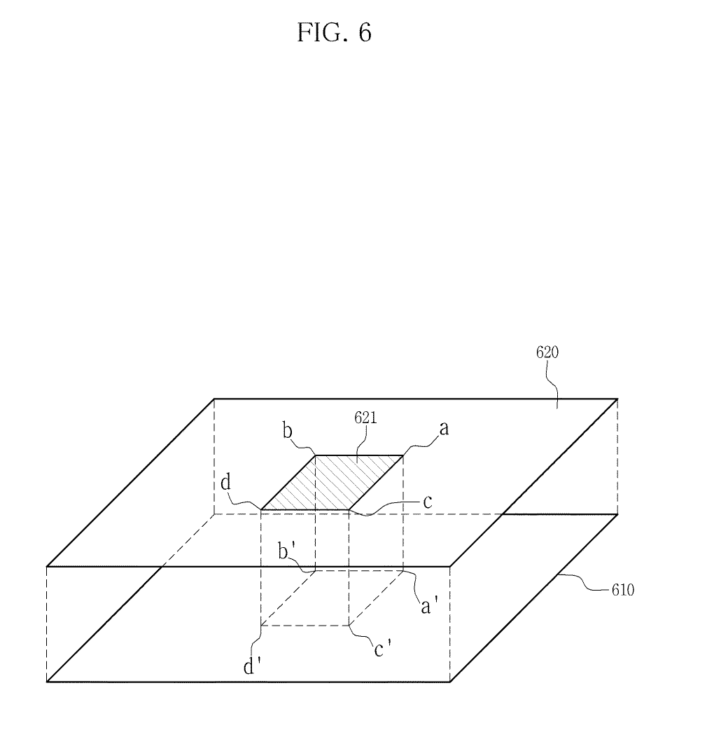

FIG. 6 is a perspective view illustration of a touch lock layer mapped into a non-lock layer in accordance with exemplary embodiments of the present disclosure. For example, the touch lock layer mapping unit 132 may map a created touch lock layer into a layer including image objects. As illustrated in FIG. 6, image objects may be disposed, positioned or included in a layer 610, and a cover layer 620 may be disposed, positioned or included on the layer 610, and one touch lock area 621 may be included in the cover layer 620. Consequently, the touch lock area 621 operates as a touch lock layer for the image objects.

While one layer 610 including image objects is represented in FIG. 6 for the simplification of description, a plurality of layers may be present in exemplary embodiments.

The touch lock layer mapping unit 132 may perform mapping by projecting coordinate information of the touch lock area 621 in the cover layer 620 into the layer 610 including image objects. For example, the touch lock layer mapping unit 132 may acquire relative coordinate information by projecting coordinates of the vertexes a, b, c, d of the touch lock area 621 in layer 620 into the layer 610 including image objects. In this example, the vertexes a, b, c, d of the touch lock area 621 in layer 620 correspond to vertexes a′, b′, c′, d′ of the layer 610 including the image objects.

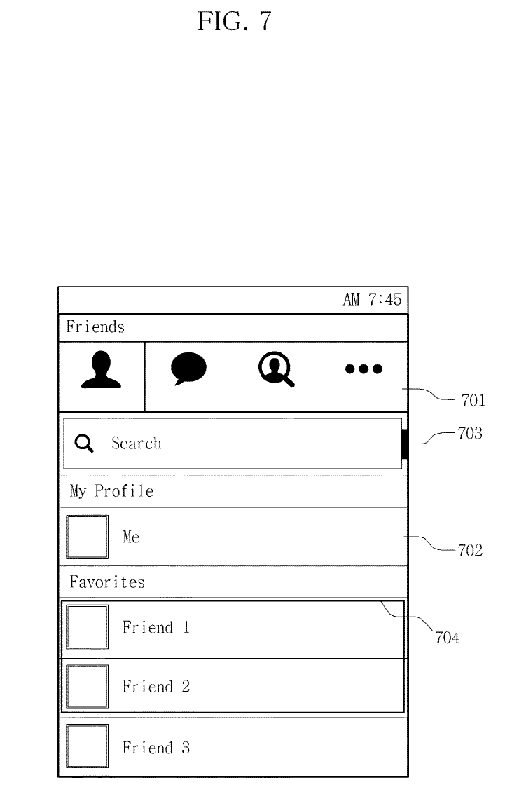

FIG. 7 illustrates a layer configured to include image objects, configured by a fixed region 701 and a non-fixed region 702. In exemplary embodiments, when a touch lock layer formed in accordance with a user input is created over the fixed region and the non-fixed region of the layer, the touch lock layer mapping unit 132 may map the touch lock layer into the fixed region.

As illustrated in FIG. 7, while the fixed region 701 is fixed with respect to the screen of the display in the layer including the image objects, the non-fixed region 702 may include a portion of the screen not displayed on the display, usually illustrated with a scroll bar 703, and the display may display the non-displayed portion in accordance with a scrolling operation. When the touch lock layer creating unit 131 creates a touch lock layer in both the fixed region 701 and the non-fixed region 702 of two layers, the touch lock layer mapping unit 132 may map the touch lock layer with reference to the fixed region 701. As such, a relative ratio of the projected and mapped coordinates nonlinearly varies when mapping is performed for the non-fixed region 702.

When a touch lock layer is created in one area of the non-fixed region, the touch lock layer may be created and mapped in the non-fixed region. In other words, a touch lock layer 704 formed in the non-fixed region 702 may be moved together with a corresponding portion of the displayed non-fixed region. For example, as illustrated in FIG. 7, the touch lock layer 704 may be moved after or with being mapped into areas of Friend 1 and Friend 2. Accordingly, even in a state in which the touch lock layer 704 does not appear on the screen due to a movement of the screen, the touch lock layer 704 mapping into the areas of Friend 1 and Friend 2 is stored as being mapped.

As a result of the mapping, in a case where the layer is enlarged, is reduced, or has a horizontal/vertical ratio changed in accordance with scrolling the screen, the control unit 130 may change the ratio of the touch lock layer in correspondence therewith. In addition, the control unit 130 stores the mapping information, so that, the mapped touch lock layer is applied when the layer is loaded thereafter.

FIG. 2 illustrates a configuration diagram of a terminal setting a touch lock layer according to exemplary embodiment. The terminal 100 may include a display 110, an input unit 120, and a control unit 130, and the control unit 130 may include a touch lock layer changing unit 133 in addition to a touch lock layer creating unit 131 and a touch lock layer mapping unit 132.

In exemplary embodiments, the display 110, the input unit 120, the touch lock layer creating unit 131, and the touch lock layer mapping unit 132 may operate in the manner described above. The terminal 100 may include at least one of a storage unit 140 and an encryption unit 150.

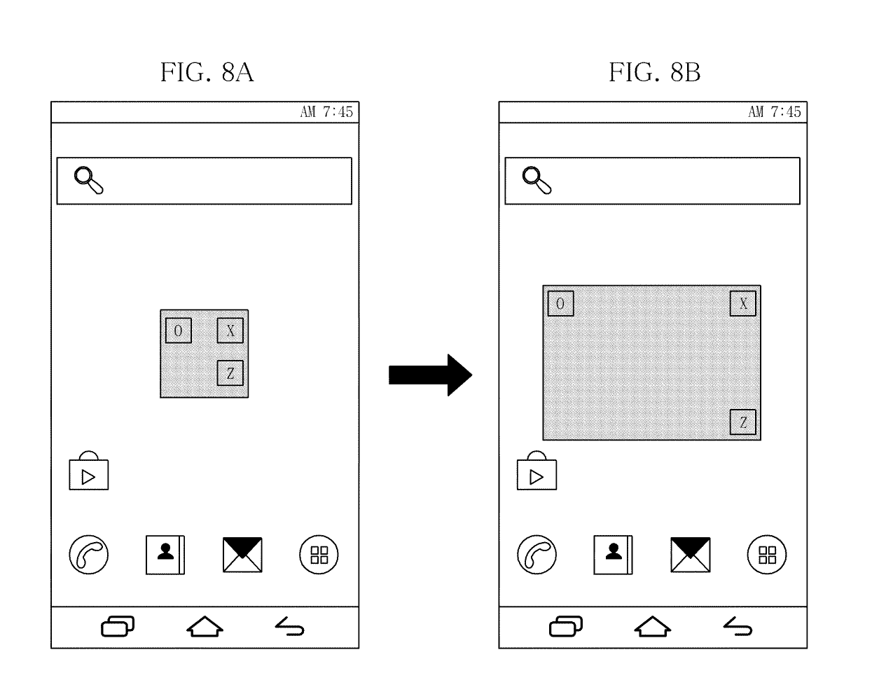

FIG. 8A and FIG. 8B illustrate changing a size of a touch lock layer us according to exemplary embodiments. The touch lock layer changing unit 133 may change the shape of the touch lock layer through a user input, and the shape may include the size, the color, and the position of the touch lock layer.

The user input may include an input using, for example, a finger, a touch pen or the like. In a case where a mouse is used, an input according to the movement of a cursor displayed on the display may be the user input. In addition, the shape of a displayed touch lock layer may be adjusted using a mouse even for touch-based terminals.

Furthermore, for a convenient operation of the touch lock layer, as illustrated in FIG. 8A and FIG. 8B, icons performing various functions may be configured on the edge of the touch lock layer.

The touch lock layer changing unit 133 may change the size, the color, the degree of transparency, and the image of a touch lock layer. FIG. 8A and FIG. 8B illustrate an example of changing the size of a touch lock layer. In a state in which a portion (z) of the touch lock layer illustrated in FIG. 8A is selected using a finger, a touch pen, or the like, the size of the touch lock layer may be enlarged as illustrated in FIG. 8B in response to a movement of the input user input.

In exemplary embodiments, an operation of drawing an edge portion other than the potion (z) is sensed, and the touch lock layer changing unit 133 may change the size of the touch lock layer in response to the sensed operation.

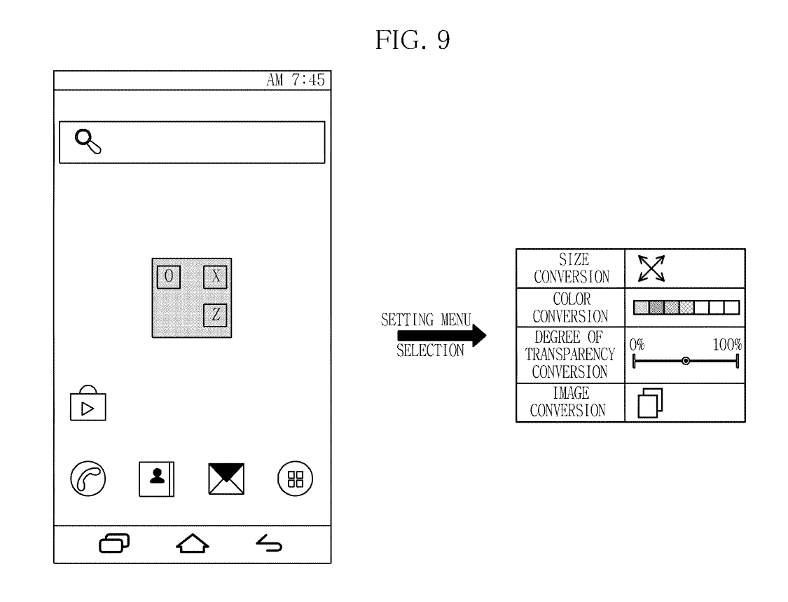

FIG. 9 illustrates a menu window for changing a touch lock layer in accordance with exemplary embodiments. Referring to FIG. 9, by inputting a specific portion of the touch lock layer or an arbitrary key set in advance, the menu window used for changing the touch lock layer illustrated in FIG. 9 may be created. When an icon corresponding to a change in size is selected, the terminal may recognize a touch input to the touch lock layer as a touch for changing the size to perform size conversion described as above. As a color of a portion corresponding to the color conversion is determined, the touch lock layer changing unit 133 may change the color of the touch lock layer, and the touch lock layer changing unit 133 may adjust the degree of transparency of the touch lock layer in accordance with the degree of a change in transparency. In addition, when an icon corresponding to the image conversion is selected, the control unit 130 may provide an application capable of displaying a list of images stored in the terminal 100 or an image list, and a selected image may be displayed in the touch lock layer.

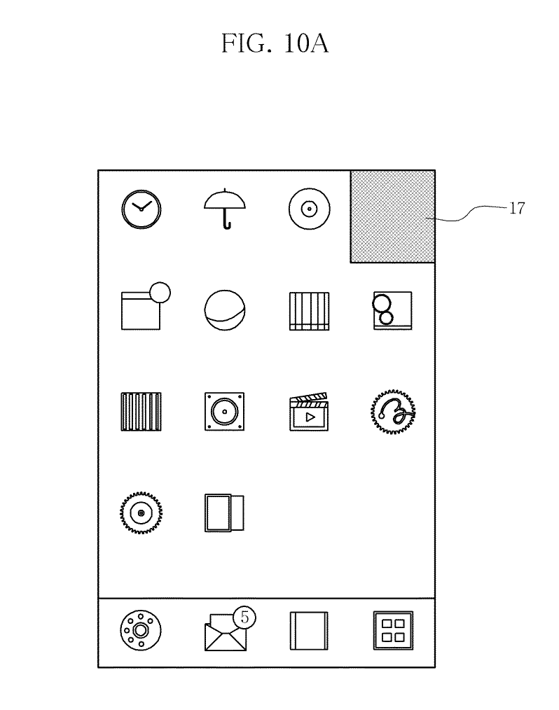

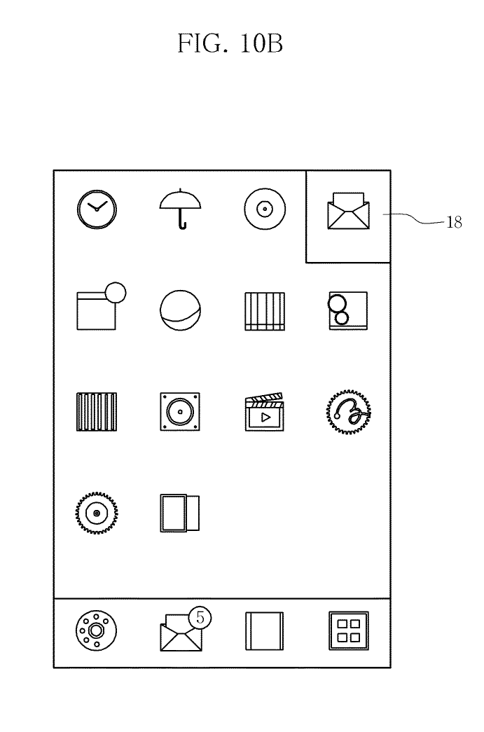

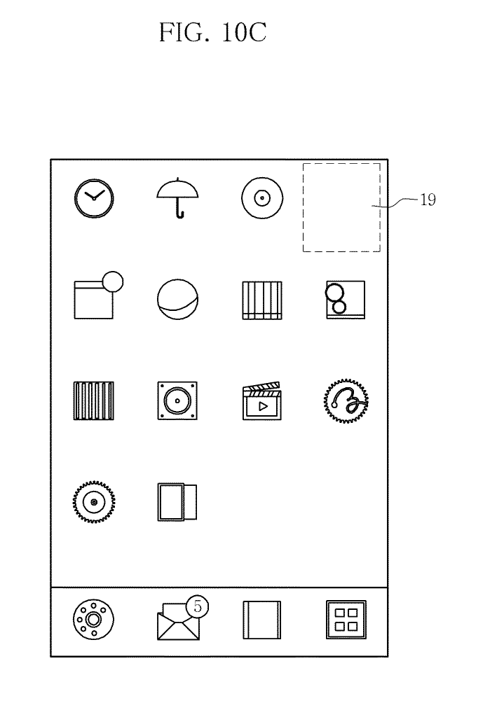

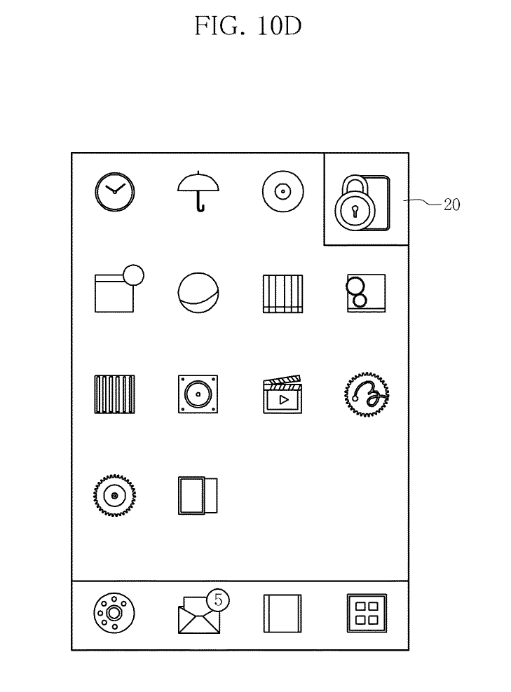

FIG. 10A, FIG. 10B, FIG. 10C and FIG. 10D illustrate touch lock layers changed in accordance with exemplary embodiments. Referring to FIG. 10A, a touch lock layer 17 of a size covering one icon is created on the upper end of the right side of a layer (here, a background screen layer and includes icons as a plurality of image objects) including image objects. By the touch lock layer changing unit 133, each touch lock layer may be formed in an opaque gray color (denoted by reference numeral 17 illustrated in FIG. 10A) as in FIG. 10A or in a transparent color 18 (such as green) as illustrated in FIG. 10B, and an icon 19 included in the layer including image objects may be displayed to be transparent as illustrated in FIG. 10C or may be represented as a specific image 20 as illustrated in FIG. 10D.

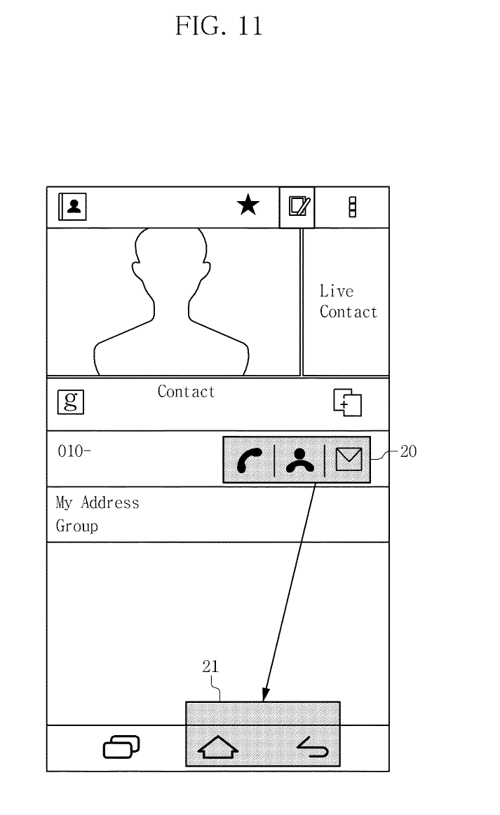

FIG. 11 illustrates moving a touch lock layer in accordance with exemplary embodiments. When a touch lock layer is touched for a control time (for example, one second) using a finger or the like, and the finger or the like moves in a state in which the touch is maintained, the touch lock layer may be moved together in accordance with the movement. As illustrated in FIG. 11, the touch lock layer changing unit 133 may move a specific touch lock layer 20 to another position 21 on the layer along the direction of an arrow in accordance with a movement in the state in which the touch is maintained.

In addition, the storage unit 140 may store mapping information of the touch lock layer for each layer and the layer including image objects. The mapping information may include address values of a part of the layer for which mapping is performed and a part set as the touch lock layer. The mapping information may include information of objects (icons or widgets representing applications) included in the layer for which mapping is performed.

When a request for a stored layer is received by the input unit 120 and is transmitted to the control unit 130, the control unit 130 may extract the requested layer from the storage unit 140 together with the mapping information of the touch lock layer and provide the requested layer to the display 110.

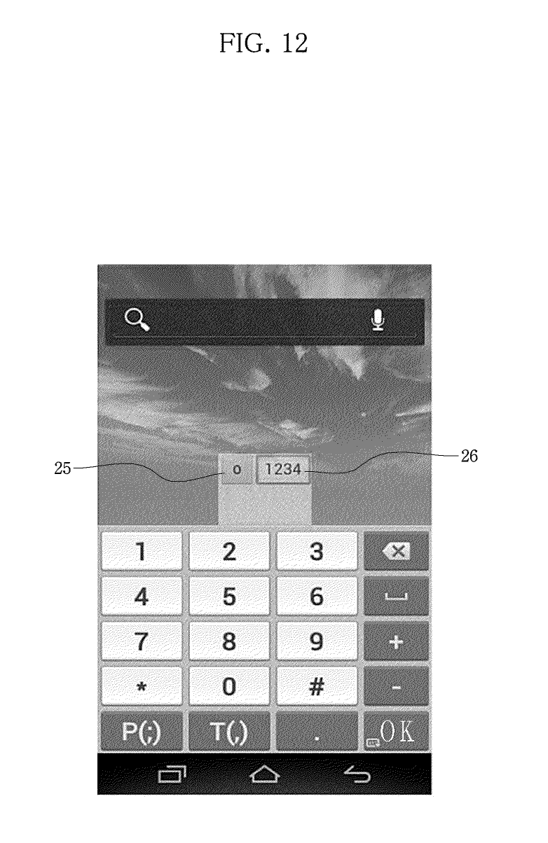

FIG. 12 illustrates setting a password to a touch lock layer in accordance with exemplary embodiment. The encryption unit 150 may set a password to the touch lock layer mapped into the layer and store the password. The encryption unit 150 may store the encryption information therein or may store the encryption information in the storage unit 140 in an encrypted form. Through such encryption, the touch lock layer may be prevented from being released by a third party, and the touch lock layer may be restricted from being edited.

In a case where the touch lock layer is to be removed or changed in the encrypted state, as illustrated in FIG. 12, the encryption unit 150 may provide an encryption input window as a portion 25 is selected, and the encryption unit 150 may display information input to a part 26 of the touch lock layer. When an input password coincides with the stored password, a change may be made for the touch lock layer.

In addition, the control unit 130 may transmit/receive data to/from the display 110, the input unit 120, and arbitrary devices electrically connected to the control unit 130. The control unit 130 may map the touch lock layer into the layer and store the touch lock layer in a state in which the touch lock layer has been finally changed.

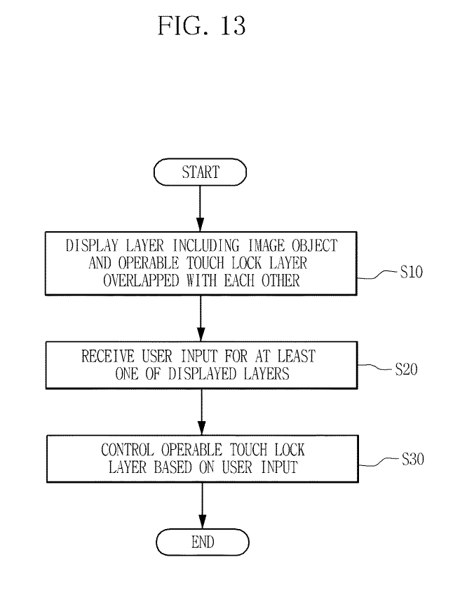

FIG. 13 is a flowchart illustrating a method for setting a touch lock layer according to exemplary embodiment. The method of setting a touch lock layer may include: overlapping a layer including image objects and an operable touch lock layer with each other and displaying the overlapped layers (S 10); receiving a user input for at least one of the displayed layers (S20); and controlling the operable touch lock layer based on the user input (S30).

While the receiving of a user input (S20) is represented to be performed after operation S10 in FIG. 13, operation S20 may be performed before or about the same time as operation S10. In exemplary embodiments, in a mapping operation, mapping information may be updated by re-performing mapping every time the touch lock layer changes.

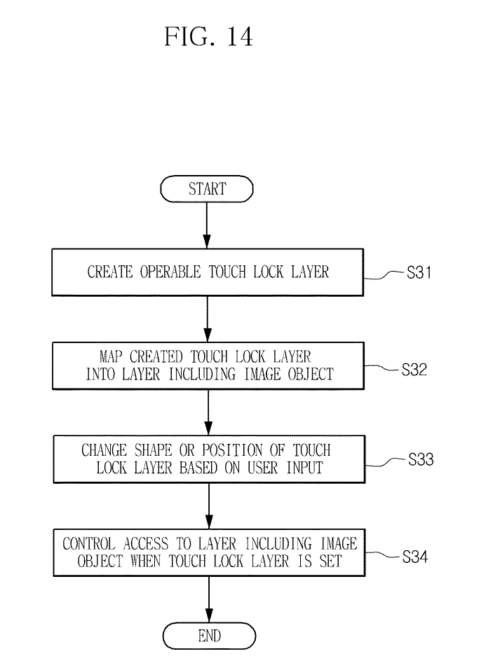

FIG. 14 is a flowchart illustrating a method for controlling an operable touch lock layer according to exemplary embodiments. Referring to FIG. 14, operation S30 of controlling an operable touch lock layer in the method of setting a touch lock layer may include operation S31 of creating the operable touch lock layer and operation S32 of mapping the created touch lock layer into the layer including image objects. Operation S30 of controlling an operable touch lock layer may include operation S33 of changing the shape or the position of the touch lock layer based on the user input. Operation S30 of controlling an operable touch lock layer may include operation S34 of controlling access to the layer including the image object, when the touch lock layer is set.

Operation S31 of creating the touch lock layer may include dividing a cover layer positioned on the layer including image objects into a plurality of areas and creating a touch lock layer for at least one area selected from among the plurality of areas.

In exemplary embodiments, operation S31 of creating the touch lock layer may include creating a closed area drawn on the display as the touch lock layer in response to a movement of the user input.

In exemplary embodiments, operation S32 of mapping the created touch lock layer into the layer including image objects may include mapping the touch lock layer into the fixed region when the closed area is drawn over the fixed region and the non-fixed region of the layer.

Operation S34 of controlling access may include displaying or removing a visual effect from the touch screen layer based on whether touch screen layer is set. Operation 34 of controlling access may include blocking or restricting input to the layer including the image object, when the touch lock layer is set. Operation S34 of controlling access may include setting or unsetting the touch lock layer based on a user input to the touch lock layer. The user input to the touch lock layer may include a gesture, a password, a user identity, a user privilege level, or the like. In operation S34, a setting or unsetting of the touch lock layer may enable or disable a previously defined or created touch lock layer.

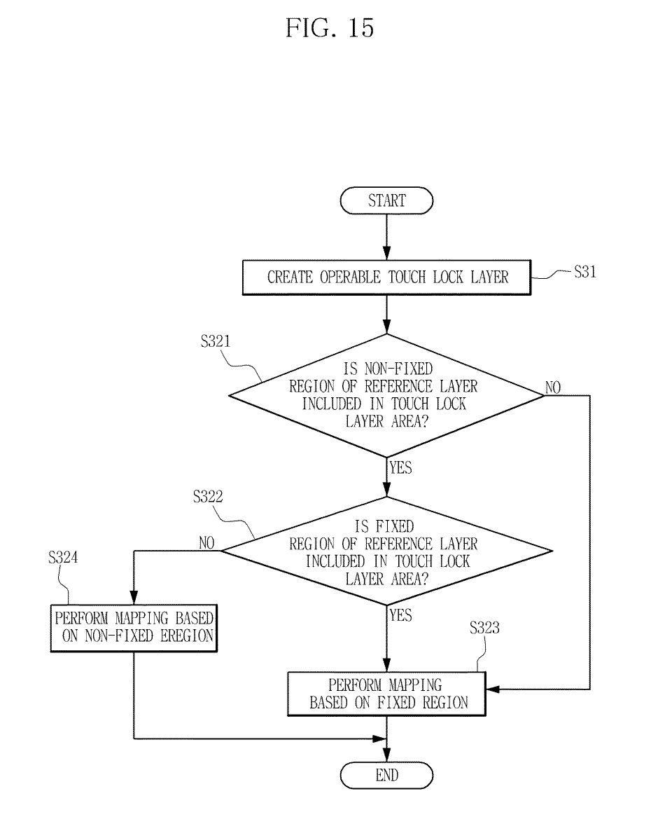

FIG. 15 is a flowchart of the mapping operation where the touch lock layer is created over a fixed region and a non-fixed region of a layer to be matched according to exemplary embodiments.

An operable touch lock layer is created (S31), and the control unit (or the touch lock layer mapping unit) of the terminal determines whether a non-fixed region of the layer is included in the created touch lock layer (including image objects) (S321). When the non-fixed region is not included, the created touch lock layer is created on the fixed region, and accordingly, mapping is performed by projecting the touch lock layer into the fixed region (S323). When the non-fixed region of the layer is included in the touch lock layer area, the control unit determines whether the fixed region of the layer is included in the touch lock layer area (S322). When the fixed region is included, the control unit performs mapping by projecting the touch lock layer into the fixed region (S323). At this time, the size of the created touch lock layer is maintained for the non-fixed region based on relative coordinate data with respect to the fixed region. On the other hand, in a case where the fixed region of the layer is not included in the touch lock layer, the touch lock layer is present on the non-fixed region, and accordingly, the control unit maps the touch lock layer into the non-fixed region (S324). When the touch lock layer is mapped into the non-fixed region, a portion into which the touch lock of the layer is mapped may be displayed on the display or may disappear on the display due to scrolling or the like. In addition, the above-described operations may be realized for each constituent part of the terminal.

In exemplary embodiments, operation S30 of controlling the operable touch lock layer may include operation S33 of changing the shape or the position of the touch lock layer.

Operation S33 of changing the shape or the position of the touch lock layer may include a sensing a movement of the user input in the state in which a predetermined portion of the touch lock layer is selected and changing the size of the touch lock layer or a process of providing the selection of at least one of the size, the color, the degree of transparency, and the image of the touch lock layer on a setting menu for the touch lock layer and changing the touch lock layer for an item selected by a user.

In exemplary embodiments, the method of setting a touch lock layer may include an operation of setting and storing a password for the touch lock layer and allowing the touch lock layer to be changeable in a case where an accurate password is input.

In exemplary embodiments, the method of setting a touch lock layer may include an operation of storing mapping information of the touch lock layer for the layer including image objects. Here, when a request for the layer including the stored image objects is made, an operation for displaying the layer including the image objects by applying the mapping information may be performed.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

While the exemplary embodiments have been shown and described, it will be understood by those skilled in the art that various changes in form and details may be made thereto without departing from the spirit and scope of the present disclosure as defined by the appended claims. In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A terminal that sets a touch lock layer, the terminal comprising:
a display to display a layer including an image object and an operable touch lock layer overlapped with each other;
an input unit to receive a user input for at least one of the displayed layers; and
a control unit to control the operable touch lock layer based on the user input.

2. The terminal that sets a touch lock layer according to claim 1, wherein the control unit comprises:
a touch lock layer creating unit to create the operable touch lock layer; and
a touch lock layer mapping unit to map the created touch lock layer into the layer including the image object.

3. The terminal that sets a touch lock layer according to claim 1, wherein the image object is at least one area of the display or an icon displayed on the display.

4. The terminal that sets a touch lock layer according to claim 2, wherein the control unit further comprises a touch lock layer changing unit to change a shape or a position of the touch lock layer based on the user input.

5. The terminal that sets a touch lock layer according to claim 1, wherein the user input includes an input using at least one of a finger, a touch pen, and a mouse.

6. The terminal that sets a touch lock layer according to claim 4, wherein the changed shape of the touch lock layer includes at least one of a size, a color, a degree of transparency, and an image of the touch lock layer.

7. The terminal that sets a touch lock layer according to claim 2, wherein the touch lock layer creating unit divides a cover layer positioned on the layer including the image object into a plurality of areas and creates a touch lock layer in at least one area selected by a user from among the plurality of areas.

8. The terminal that sets a touch lock layer according to claim 2, wherein the touch lock layer creating unit creates at least one closed area drawn on the display as the touch lock layer in response to a user input for the layer including the image object.

9. The terminal that sets a touch lock layer according to claim 1, further comprising an encryption unit to set and to store a password for the touch lock layer and to allow the touch lock layer to be changeable in a case where an accurate password is input.

10. The terminal that sets a touch lock layer according to claim 1, further comprising a storage unit to store mapping information of the touch lock layer for the layer including the image object.

11. A method of setting a touch lock layer, the method comprising:
displaying a layer including an image object and an operable touch lock layer overlapped with each other;
receiving a user input for at least one of the displayed layers; and
controlling the operable touch lock layer based on the user input.

12. The method of setting a touch lock layer according to claim 11, wherein said controlling of the operable touch lock layer further comprises:
creating the operable touch lock layer; and
mapping the created touch lock layer into the layer including the image object.

13. The method of setting a touch lock layer according to claim 11, wherein the image object is at least one area of the display or an icon displayed on the display.

14. The method of setting a touch lock layer according to claim 13, wherein said controlling of the operable touch lock layer based on the user input comprises changing a shape or a position of the touch lock layer based on the user input.

15. The method of setting a touch lock layer according to claim 13, wherein the user input includes an input using at least one of a finger, a touch pen, and a mouse.

16. The method of setting a touch lock layer according to claim 14, wherein the changed shape of the touch lock layer includes at least one of a size, a color, a degree of transparency, and an image of the touch lock layer.

17. The method of setting a touch lock layer according to claim 15, wherein, in said changing of a shape or a position of the touch lock layer, a selection of at least one of a size, a color, a degree of transparency, and an image of the touch lock layer is provided on a setting menu for the touch lock layer, and the touch lock layer is changed for an item selected by a user.

18. The method of setting a touch lock layer according to claim 11, wherein, in said creating of the operable touch lock layer, a cover layer positioned on the layer including the image object is divided into a plurality of areas, and a touch lock layer is created in at least one area selected from among the plurality of areas.

19. The method of setting a touch lock layer according to claim 12, wherein, in said creating of the operable touch lock layer, a closed area drawn on the display is created as the touch lock layer in response to a movement of the user input.

20. The method of setting a touch lock layer according to claim 11, further comprising setting and storing a password for the touch lock layer and allowing the touch lock layer to be changeable in a case where an accurate password is input.

21. The method of setting a touch lock layer according to claim 11, further comprising storing mapping information of the touch lock layer for the layer including the image object.
